(19) United States
(12) Patent Application Publication
(10) Pub. No.: US 2025/0129463 A1
(43) Pub. Date: Apr. 24, 2025

(54) Method of Repairing a Defect and Device

(71) Applicant: Rawwater Applied Technology Limited, Culcheth, Cheshire (GB)

(72) Inventor: Robert Eden, Culcheth, Cheshire (GB)

(73) Assignee: Rawwater Applied Technology Limited, Culcheth, Cheshire (GB)

(21) Appl. No.: 18/689,221

(22) PCT Filed: Sep. 7, 2022
(86) PCT No.: PCT/EP2022/074896

§ 371 Date: Mar. 5, 2024

(30) Foreign Application Priority Data
Sep. 7, 2021 (GB) 2112740.2

(51) Int. Cl. C23C 4/123; B23P 6/00; C23C 4/02; C23C 4/08

(52) U.S. Cl. CPC C23C 4/123; C23C 4/02; C23C 4/08; B23P 6/00

(57) ABSTRACT

A method of and apparatus for repairing a defect in a surface are provided, the method comprising the steps of a) providing a bolus of an at least partially liquid alloy in a charge chamber, the charge chamber having a closable outlet and a closable pressure inlet; b) introducing a pressurized fluid to the charge chamber via the pressure inlet and accelerating the bolus such that the bolus is ejected from the charge chamber via the outlet; c) directing the bolus along a pathway between the charge chamber and the defect such that the bolus contacts the defect; and d) solidifying the at least partially liquid alloy while it is contact with the defect.

The present invention relates to repairing defects in surfaces. In particular, the present invention relates to a method of repairing surfaces with a bolus of an at least partially liquid alloy composition, as well as apparatus suitable therefor and uses of said apparatus.

### BACKGROUND

It is common for the surfaces of objects to develop defects, such as holes, cracks, fissures, fractures, pits, splits, pores, and punctures, which prevent or limit the ability of the object to perform its function. For example, pipes or containers may develop cracks or holes through which their contents may leak. In these circumstances, it is necessary to repair the defect, ideally in situ, which may be difficult to achieve if the defect is hard to reach or is in a hazardous location.

A common method for repairing surface defects is to apply a patch of material over the affected area. For example, affixing a metal plate (e.g. by welding) to a barrel, or applying a curable polymer resin. However, these methods often require the removal of the affected object to a more suitable environment and/or manual application.

Cold spraying involves accelerating heated solid micro particles towards a surface at very high velocities using a carrier gas. The heated, micro particles are accelerated at such a velocity that they plastically deform on impact with the surface. The deformed metal particulates bond mechanically with the surface, and with other metal particles, to form a layer on the surface. Cold spraying has been used to deposit metallic layers. Cold spraying, however, has poor deposition efficiency, particularly for alloy powders. Furthermore, the size of the micro particles suitable (typically 1 to 50 micrometres) for cold spraying is limited to a narrow range, and depending on the type of micro particle used, supersonic velocities (typically 500 to 1000 m/s) are required to cause the required deformation on impact with the surface. Such high velocities are often created by heating the carrier gas to temperatures in excess of 800° C. As such, the extreme temperatures and velocities used in cold spraying often cause damage to the surface to be sealed, and is certainly unsuitable for fragile surfaces. Cold spraying is also only suitable for sealing surfaces under atmospheric conditions, and cannot be used under submerged aquatic conditions. This is because the velocity of the metal particles is reduced as a result of friction with surrounding water, and furthermore the thermal energy of the particles is dissipated into the surrounding water before the micro particles hit the surface. As such, the micro particles cool in the water, lose their elasticity (ability to deform on impact), and thus simply bounce off the surface to be coated.

WO 2020/002886 A1 sets out a method of sealing a surface comprising: providing a metallic composition; providing a propellant; heating the metallic composition to above the melting point of the metallic composition to provide an at least partially liquid metallic composition; accelerating the at least partially liquid metallic composition towards the surface by means of the propellant; and applying the at least partially liquid metallic composition to the surface. This method allows a spray of at least partially liquid metal to be directed to a surface. Upon contact with the surface, the liquid metallic droplets will deform and cool. As the droplets cool, they solidify on the surface to form a coating. The coating will reinforce and/or seal the surface onto which the stream of metallic droplets is directed. The method can be used to seal leaks, in particular active leaks. However, in certain circumstances, the liquid metallic droplets that form the spray are vulnerable to deflection by leaking high velocity material before contacting the surface, or the sealing may fail should the leak be in a container that is under particularly high pressure.

Therefore a need remains for a method and suitable apparatus for repairing defects in surfaces which addresses one or more of the aforementioned problems.

### SUMMARY OF INVENTION

According to a first aspect of the present invention, there is provided a method of repairing a defect in a surface comprising the steps of:
a) providing a bolus of an at least partially liquid alloy in a charge chamber, the charge chamber having a closable outlet and a closable pressure inlet;
b) introducing a pressurized fluid to the charge chamber via the pressure inlet and accelerating the bolus such that the bolus is ejected from the charge chamber via the outlet;
c) directing the bolus along a pathway between the charge chamber and the defect such that the bolus contacts the defect; and
d) solidifying the at least partially liquid alloy while it is contact with the defect.

The bolus of at least partially liquid alloy is a discrete, contiguous quantity of at least partially liquid alloy that is distinct from a spray of at least partially liquid alloy (i.e. a number of distinct, discontinuous droplets of at least partially liquid alloy). The nature of the bolus allows the liquid alloy to be provided at higher velocities and have greater momentum, without depositing excessive quantities of material. As a result, the bolus is more resistant to deflection by material leaking from a defect, and is more capable of at least partially penetrating into the defect, providing a more robust repair. The at least partially liquid alloy is preferably entirely liquid. The bolus may also be referred to as a ‘slug’.

Solidification of the at least partially liquid alloy is achieved by the cooling of the at least partially liquid alloy while it is in contact with the defect. The at least partially liquid alloy loses heat to the surrounding environment. In embodiments, this rate of heat loss (and hence rate of solidification) may be increased by the application of a coolant (e.g. a low-temperature fluid).

In cases where the defect is relatively large compared to the volume of the bolus, it may be necessary to repeat steps a) to c) until sufficient material is provided to fully repair the defect.

Step (c) of directing the bolus to the defect may comprise providing a delivery line that defines at least a portion of the pathway. The delivery line protects the bolus from exterior forces and ensures that it correctly travels along the pathway. In addition, the delivery line allows the pathway to be non-linear and extends the maximum possible length of the pathway by preventing dissipation of the pressurized fluid.

The delivery line may be positioned by a robot or a remote deployment arm, optionally wherein the robot is a snake-arm robot. The positioning of the delivery line by a robot allows the placement of the delivery line to be performed remotely. This allows for the repair of defects in environments which are inimical to human operators (for example, in asphyxiant or toxic atmospheres, and areas of high temperature or radiation). Snake arm robots, and similar with high numbers of degrees of freedom, are particularly suitable as they also allow the delivery line to be directed to otherwise inaccessible defects.

The delivery line may be operable to limit heat loss from and/or provide heat to the bolus. This allows the delivery line to be extended without risking premature solidification of the bolus. Limiting heat loss may be achieved by the inclusion of insulation within or around the delivery line. Providing heat may be achieved by the inclusion of heating elements within or around the delivery line.

Step (a) of providing the bolus to the charge chamber may comprise:
i) at least partially melting a solid alloy and introducing the resulting at least partially liquid alloy into the charge chamber; or
ii) introducing the solid alloy to the charge chamber and at least partially melting in situ.

In other embodiments, the solid alloy may be partially melted prior to introduction to the charge chamber, with further melting occurring within the charge chamber.

The pressurized fluid may be heated, optionally to above the melting point of the alloy. Heating the pressurized fluid assists in maintaining the alloy in its at least partially liquid state. The pressurized fluid may be a compressed gas (e.g. compressed air) or steam. Compressed gas may be provided by a vessel of already compressed gas, or may be provided on demand by a compressor. The pressurized fluid may have a pressure up to about 30 bar, preferably in the range of about 1 to about 30 bar, more preferably in the range of about 5 to about 25 bar, most preferably in the range of about 10 to about 20 bar. Alternatively, the pressurized fluid may have a pressure in the range of 1 to 15 bar, preferably in the range of 3 to 8 bar. Where the apparatus is used to repair a defect which is an active leak, it is preferred that the pressure of the pressurized fluid (i.e. the pressure applied to the bolus) exceeds the pressure of the fluid leaking from the defect. It will be understood that the required pressure of the pressurized fluid is based on the length of the pathway between the outlet and the defect (e.g. with the length of the delivery line) and, if present, the diameter of said delivery line. Repair of an active leak means that the rate of the leak is reduced or is completely prevented.

The alloy preferably has a melting point of below around 300° C., more preferably has a melting point below 150° C., most preferably has a melting point below 100° C. The alloy may be selected from the group consisting of bismuth alloys, indium alloys, antimony alloys, tin alloys, lead alloys and gallium alloys. The alloy preferably expands upon solidification. The alloy preferably comprises a bismuth alloy (i.e. an alloy which is predominantly bismuth) or an alloy comprising bismuth. As used herein, the term alloy will be understood to be an alloy containing one or more metals. For example, a bismuth alloy will be understood to be a bismuth-containing alloy, but may contain other metals. One exemplary alloy is Field's metal, comprising 32.5 wt % Bi, 51 wt % In, and 16.5 wt % Sn. The alloy may be one of the compositions described in U.S. Pat. No. 6,474,414B1, particularly those described from column 3 line 8 to column 4 line 47. In one example, the alloy may comprise about 91 to 97% by weight bismuth and about 3 to 9% by weight silver. In another example, the alloy may comprise at least 50% by weight bismuth, 30 to 35% by weight tin, and 1.8 to 2.5% by weight antimony. In another example, the alloy may be as defined in EP 3810816 A1, particularly the alloy as defined in the claims thereof. The contents of U.S. Pat. No. 6,474,414 and EP3810816 are incorporated herein in their entirety.

In embodiments, the alloy has a minimal dimensional change on solidification, for example, shrinking by less than 5%, preferably less than 3%, most preferably less than 1%. It is preferable to use an alloy which expands or has no change in volume upon solidifying as this provides stronger repairs compared to materials which contract upon solidification. Since the alloy is applied to a surface in at least partially liquid form, if it were to contract upon solidification, it would pull away from the edges of the defect and therefore the repair would be less effective. In contrast, according to the method of the present invention, having an alloy which expands or retains a constant volume upon cooling or solidifying results in a repair which mechanically interlocks with the edges of the defect.

In the method, it may be that in step (b) of introducing a pressurized fluid to the charge chamber via the inlet and accelerating the bolus such that the bolus is ejected from the charge chamber via the outlet:
i) the outlet and pressure inlet are opened simultaneously so that the bolus is ejected as the pressurized fluid is introduced; or
ii) the outlet is opened first and the pressure inlet is opened second so that the bolus is ejected as the pressurised fluid is introduced; or
iii) the pressure inlet is opened first and the pressurized fluid is introduced to the charge chamber, and the outlet is opened second so that the bolus is ejected from the charge chamber as the outlet is opened.

These particular operating conditions allow for the ejection of the at least partially liquid alloy as a bolus, rather than as a spray, as the discrete quantity of alloy is accelerated as a single, contiguous mass. The mass of the bolus is selected relative to the size of the defect, being sufficient to repair the defect (e.g. replace any material missing from the surface) without including excessive material. In general terms, the bolus may have a mass of up to 100 g, where the defect is sufficiently large that this quantity of alloy is insufficient to effect a repair, multiple boluses may be used. The velocity with which the bolus is ejected will vary depending on the pressure of the pressurized fluid, the mass of the bolus, the diameter of the charge chamber and, where used, the diameter of the delivery line.

In embodiments where a mould is introduced around the defect site in order to contain the alloy bolus around the defect, the mass of the alloy bolus will be specific to the volume of the mould, and typically range from 300 g to 5 kg.

The defect may be an active leak. In other words, the defect may be providing a route through which the contents of the object to be repaired is escaping. The method may further comprise the step of deflecting material being ejected by the active leak away from the pathway. Such a step will happen at least simultaneously with step c). This deflection may be achieved by the provision of a deflection fluid along a deflection line. Optionally the deflection fluid is compressed gas or steam, or may be the pressurized fluid. In cases where the defect is an active leak, it is preferable for the bolus to be ejected at a velocity sufficient to give it a greater momentum than the material being ejected via the active leak.

The method may further comprise a cleaning step wherein a cleaning fluid is delivered to the defect. The cleaning fluid may be compressed gas or steam, or may be the pressurized fluid. The application of the cleaning fluid prior to the delivery of the bolus allows for any particulates, grime, dust, dirt and the like to be removed from the surface, allowing the alloy to be more securely retained due to improved contact with the defect. The cleaning fluid may be delivered via the delivery line or via the deflection line. Alternatively, the cleaning fluid may be delivered via a dedicated cleaning line.

The bolus may penetrate at least partially into the defect. In such embodiments, the alloy not only sits over the defect, but sits within the defect and, optionally extends beyond the defect into the lumen of the object. Entering the defect increases interaction between the defect and the alloy, enhancing the strength of the repair. The alloy extending beyond the defect allows it to interact with the interior surface of the object, mechanically locking the repair such that outward removal (e.g. by pressure within the object) requires breaking of the alloy itself.

The defect may be at least partially submerged in an aqueous fluid. Aqueous fluids may include water, saline, sea water, mixtures of oil and water, and the like. Alternatively, the defect may be at least partially submerged in a non-aqueous fluid, such as oil. In some embodiments of the present invention, the defect may be at least partially submerged in water. Advantageously, preference to alloys with melting points of below 100° C. means that the alloy has a lower melting point than the boiling point of water. As such, the bismuth alloy remains in liquid form when submerged under water until it cools and becomes a solid, and furthermore does not result in the generation of steam. Similarly, bismuth alloy is not reactive with water, in contrast to, for example, liquid aluminium which reacts violently or explosively with water. As such, the alloy does not comprise compositions which react violently with water when in their liquid state. This may be a chemical reaction or may be due to the rapid production of steam due to the high temperature required to melt the alloy.

The method may further comprise the step of placing a mould around the defect prior to the step of directing the bolus along a pathway between the charge chamber and the defect such that the bolus contacts the defect, the mould operable to hold the alloy in contact with the defect. The use of the mould ensures that the alloy remains in contact with the defect as it cools and solidifies. The mould may also be shaped to produce a solidified alloy with a beneficial shape. For example, the mould may produce a cooled alloy encircling the object in which the defect is located, reinforcing the repair as failure would require breakage of the solidified alloy, not merely separation from the defect and/or surface.

The method may further comprise a step of purging debris from the delivery line and/or charge chamber. The step of purging debris may comprise passing of pressurized fluid through the delivery line and/or charge chamber, for example, via a purge line and purge valve.

A second aspect of the present invention relates to an apparatus for repairing defects, the apparatus comprising:
a charge chamber for holding at least partially liquid alloy, the charge chamber comprising a pressure inlet and an outlet; and
a pressure line in fluid connection with the pressure inlet and connectable to a pressurized fluid source.

The apparatus is able to direct a bolus of at least partially liquid alloy to a defect by propelling it with a pressurized fluid. The bolus deforms on impact with the defect, matching its shape, before cooling and solidifying to effect a repair of the defect. The apparatus is also able to direct the at least partially liquid alloy to the defect as a spray. The charge chamber is constructed such that it can withstand the temperatures of the at least partially liquid metal and the pressure of the pressurized fluid. In other words, any material that is capable of holding the molten alloy without being rapidly degraded by the alloy. For example, the charge chamber may be constructed of mild steel, stainless steel, or copper. These materials are solid in construction. The charge chamber may be in any suitable form, preferably the charge chamber is a section of pipe or tubing. The internal volume of the charge chamber restricts the maximum volume of alloy that may be contained, and hence limits the maximum size of the bolus. The charge chamber may be cylindrical in nature and may have an internal diameter up to 150 mm, preferably in the range of 5 and 25 mm, more preferably in the range of 10 to 20 mm, most preferably about 15 mm. In embodiments where the alloy is at least partially melted in the charge chamber, preferred charge chamber diameters are in the range of 20 to 150 mm, more preferably in the range of 50 to 100 mm, most preferably around 70 mm. In embodiments where the alloy is at least partially melted in an alloy chamber, preferred charge chamber diameters are in the range of 2 to 20 mm, more preferably in the range of 4 to 15 mm, most preferably in the range of 5 to 13 mm.

The pressure line is connectable to a pressure fluid source. In embodiments, the pressure fluid source is part of the apparatus and the pressure line is connected to the pressure fluid source. The pressure fluid source may be a vessel of compressed gas (e.g. a cylinder of compressed gas, such as air or nitrogen). Alternatively, the pressure fluid source may be a compressor. Further alternatively, the pressure fluid source may be a boiler.

The apparatus may further comprise a delivery line in fluid communication with the outlet. The delivery line extends the maximum possible length of the pathway between the outlet and the defect by preventing dissipation of the pressurized fluid and preventing exterior forces from interfering with the bolus following its ejection from the charge chamber. Conceivably, the delivery line may be of any suitable length required to define the pathway between the outlet and the defect. The delivery line may be up to 50 m in length, alternatively up to 25 m in length, further alternatively up to 10 m in length, yet further alternatively up to 5 m in length.

The delivery line may be flexible. This allows the pathway to be non-linear, allowing access to hard to reach defects. The delivery line may be made of any suitable material, for example braided metal (e.g. mild steel, stainless steel, aluminium, or copper), a polymeric tube or silicone piping. In embodiments, the delivery line is a polymeric tube or silicone piping within a sheath of braided metal. The diameter of the tubing line may be in the range of 0.1 to 25 mm, preferably 1 to 15 mm, more preferably 2 to 15 mm, further preferably 3 to 13 mm, and most preferably about 6 mm. In embodiments, the diameter of the tubing narrows towards the distal end (i.e. the end proximate to the defect); this increases the velocity of the bolus. In other embodiments, the diameter of the tubing is constant along its length.

The delivery line may be provided with a handle proximate to the outlet, optionally wherein the handle comprises means for releasing the at least partially liquid alloy. The handle makes the delivery line easier to position for the operator, and enhances safety by increasing the distance between the operator and the bolus. Advantageously, the handle may incorporate means of activating the pressure inlet and the outlet to release the bolus.

The delivery line may be compatible with, or comprise, a robot operable to position the delivery line (e.g. a snake-arm robot). The use of a robot allows the delivery line to be positioned without the need for the human operator to be present, thereby allowing use of the apparatus in hazardous environments. Snake-arm robots, and similarly flexible robots, are especially useful as they are able to access defects in otherwise inaccessible locations.

The delivery line may comprise insulation and/or heating apparatus. The inclusion of insulation and/or heating apparatus in or around the delivery line prevents the bolus of at least partially liquid alloy from cooling (and potentially solidifying) prematurely. The delivery line may be at least partially sheathed in heating tape.

The delivery line may comprise a nozzle at its terminus. The nozzle may be cone shaped, cylindrical shaped, cuboid shaped, or arcuate shaped. The nozzle aperture may be circular, rhombus or arcuate shaped. Indeed any suitable nozzle shape or nozzle aperture shape may be used. The shape of the nozzle or the nozzle aperture may be selected to provide a particular shape to the bolus.

The charge chamber may further comprise an alloy inlet. The alloy inlet allows for the introduction of the alloy that will form the bolus to the charge chamber, in either the solid or at least partially liquid state. Providing a specific inlet for this purpose allows the charge chamber to be quickly reset, so that the apparatus may rapidly deliver multiple boluses.

The apparatus may further comprise an alloy chamber in fluid connection with the alloy inlet, optionally wherein the alloy chamber comprises a heater operable to at least partially melt a portion of solid alloy. The alloy chamber allows a store of alloy to be prepared ready for use. The alloy chamber may store the alloy as a solid that is introduced to the charge chamber and melted in situ, preferably the alloy is a particulate solid, which allows for it to be easily portioned as it is introduced to the charge chamber. The optional heater allows the alloy to be at least partially converted to the liquid state prior to its introduction to the charge chamber, thereby reducing the time needed between deliveries of the boluses. The alloy chamber has a volume suitable for delivery of at least one appropriately sized bolus, preferably up to 1 litre. An appropriate size for the bolus can be determined based on the size of repair to be effected and, if used, the size of the mould that is secured around the defect.

The alloy chamber may further comprise a balance inlet and the apparatus further comprises a balance line in fluid connection with the balance inlet, optionally wherein the balance line is also in fluid connection with the pressure line. The balance inlet and balance line allow for the introduction of a balance fluid to the alloy chamber, the balance fluid operable to push the alloy from the alloy chamber to the charge chamber. Where the balance line is in fluid connection with the pressure line, the balance fluid is the same as the pressurized fluid. Alternatively, the balance line may be fluidly connected to a dedicated balance fluid source.

The charge chamber may comprise insulation and/or a heater. These features allow for the at least partially liquid alloy to be kept in the at least partially liquid state and/or for solid alloy to be at least partially converted to liquid alloy within the charge chamber.

The apparatus may further comprise one or more sensors (e.g. temperature/pressure sensors) and/or a control system. The inclusion of sensors allows for the operator to monitor the apparatus and determine when it is ready to deliver the bolus, for example, by monitoring the temperature of the alloy within the charge chamber and pressure in the pressure line. The control system allows for easy control of the temperature and/or pressure, optionally in response to a readout from the one or more sensors.

The apparatus may further comprise a deflection line. The deflection line is operable to deliver a deflection fluid that deflects material that may be leaking from the defect from the pathway along which the bolus is to travel. The deflection line may be fluidly connected with the pressure line. Alternatively, the deflection line may be fluidly connected to a dedicated deflection fluid source.

The apparatus may further comprise a housing containing one or more of the charge chamber, at least a portion of the pressure line, at least a portion of the delivery line if present, the alloy chamber if present, and at least a portion of the balance line if present, optionally wherein the housing comprises insulation and/or a heater. The housing ensures that the apparatus is protected and allows for easier transportation. Should the housing comprise insulation and/or a heater, the ease with which the at least partially liquid alloy can be kept in the liquid state and/or the solid alloy can be at least partially converted to liquid alloy is increased.

The apparatus may further comprise a purge line. The purge line is operable to purge the system to ensure the delivery line is kept clear from debris and/or to clean the surface containing the defect using the pressurized fluid. The purge line allows fluid connection between the pressure line and the charge chamber that bypasses the alloy chamber (if present) and at least a portion of the charge chamber. In embodiments, the purge line bypasses the charge chamber entirely, providing fluid communication between the pressure line and the delivery line. This allows purging of the delivery line and/or cleaning of the surface containing the defect while retaining at least partially liquid alloy in the charge chamber.

A third aspect of the present invention relates to the use of the apparatus of the second aspect of the present invention to apply a bolus of at least partially liquid alloy to a defect in a service. This may be achieved by operating the outlet and the pressure inlet as follows once the charge chamber contains the bolus of at least partially liquid alloy:
i) opening the outlet and pressure inlet simultaneously; or
ii) opening the outlet before opening the pressure inlet; or
iii) opening the pressure inlet prior to opening the outlet so that the bolus is ejected from the charge chamber as the outlet is opened.

Alternatively, this may be achieved by operating the pressure inlet, the alloy inlet, and the outlet as follows in the absence of the bolus of at least partially liquid alloy from the charge chamber:
i) opening the pressure inlet before the alloy inlet and the outlet are opened simultaneously; or
ii) opening the values in the order of:
   a. pressure inlet
   b. alloy inlet
   c. outlet

A fourth aspect of the present invention relates to the use of the apparatus of the second aspect of the present invention to apply a spray of at least partially liquid alloy to a defect in a surface. This may be achieved by introducing the at least partially liquid alloy to the charge chamber while both the outlet and pressure inlet are open. The at least partially liquid alloy is depleted as it is introduced, with droplets being broken off to form the spray. Alternatively or additionally, this may be achieved through having the purge valve open to introduce further pressurized gas so as to effect breaking up of the bolus to form a spray of discrete droplets.

A fifth aspect of the present invention relates to the use of the apparatus of the second aspect of the present invention to apply a jet of at least partially liquid alloy to a defect in a surface. This may be achieved by pressurizing a large quantity of the at least partially liquid alloy and ejecting it from the outlet. The jet is a continuous flow of at least partially liquid alloy, as opposed to the discrete quantity of at least partially liquid alloy that forms the bolus. For example, the leading edge of the jet of at least partially liquid alloy may contact the defect while the jet is still being extruded from the outlet or, if used, the delivery line.

Any heater described herein may comprise one or more resistive heating elements (e.g. heating tape). Alternatively or additionally, the heater may be a pipe through which heated fluid, such as steam or water, is passed. Alternatively or additionally, the heater may be pyrotechnical means.

Any of the outlet, pressure inlet, or balance inlet, or alloy inlet or purge valve may comprise a valve operable to be switched from an open to a closed position, and vice versa. The valve is able to be rapidly switched from the open to the closed position, for example in less than 1 second, in less than 0.5 seconds, in less than 0.2 seconds, or less than 0.1 seconds. Suitable valves include, but are not limited to, ball, butterfly, or needle, and may be mechanically actuated or electromechanically actuated (e.g. solenoid valves).

It will be appreciated that any features described in respect of one aspect of the present invention may be combined with features described in respect of another aspect of the present invention.

### DESCRIPTION OF FIGURES

FIG. 1 is a schematic of an embodiment of the apparatus of the second aspect of the present invention, the apparatus comprising a charge chamber (10) having a pressure inlet (20) and a pressure outlet (30), and a pressure line (40).

FIG. 2 is a schematic of an embodiment of the apparatus of the second aspect of the present invention, the apparatus comprising a charge chamber (10) having a pressure inlet (20) and a pressure outlet (30), a pressure line (40), and a delivery line (50).

FIG. 3 is a schematic of an embodiment of the apparatus of the second aspect of the present invention, the apparatus comprising a charge chamber (10) having a pressure inlet (20), a pressure outlet (30) and an alloy inlet (60), a pressure line (40), a delivery line (50), and an alloy chamber (70).

FIG. 4 is a schematic of an embodiment of the apparatus of the second aspect of the present invention, the apparatus comprising a charge chamber (10) having a pressure inlet (20), a pressure outlet (30) and an alloy inlet (60), a pressure line (40), a delivery line (50), an alloy chamber (70) having a balance inlet (80), and a balance line (90).

FIG. 5 is a schematic of an embodiment of the apparatus of the second aspect of the present invention, the apparatus comprising a charge chamber (10) having a pressure inlet (20), a pressure outlet (30) and an alloy inlet (60), a pressure line (40), an alloy inlet (60), a pressure line (40), a delivery line (50), and an alloy chamber (70),

FIG. 6 is a schematic of an embodiment of the apparatus of the second aspect of the present invention, the apparatus comprising a charge chamber (10) having a pressure inlet (20), a pressure outlet (30), an alloy inlet (60), and a purge valve (100), a pressure line (40), a delivery line (50), an alloy chamber (70), and a purge line (110).

### DETAILED DESCRIPTION

The present invention provides a method and apparatus for repairing a defect in a surface. Defects include holes, cracks, fissures, fractures, pits, splits, pores, and punctures, which prevent or limit the ability of the object to perform its function. For example, objects that are hollow, e.g. containers or pipes, may develop leaks where defects span the thickness of the surface.

Defects that may be repaired by the method and apparatus of the present invention may occur in variety of surfaces, for example wooden surfaces, metallic surfaces, geological formation surfaces (e.g. stone or rock), composite surfaces (e.g. cement), polymeric surfaces and architectural surfaces. The defects may occur in hazardous locations, such as those contaminated by radioactive, chemical, or biological waste, or those exposed to excessive temperatures or harmful atmospheres. Defects that may be repaired may occur in oil and gas wellbores and pipelines; chemical refinery equipment; aircraft components such as aircraft fuselage and wings; military equipment; mining equipment; and marine vehicles such as submarines, ships and boats.

As used herein, the term repairing and similar terms will be understood to mean the restoration of the object comprising the surface that is to be repaired to its former functionality. For example, a previously cracked and leaking pipe will be able to withstand the pressure to which it was originally designed to handle. The repair is effected by filling any areas from which surface material has been displaced (through chemical processes, such as corrosion, or physical processes, such as impact) with an alloy composition. The alloy composition may also contact the surface in other areas. In certain areas of the art, the terms “recovery” and “seal” may be used interchangeably with the term “repair”. For example, in the nuclear industry, the restoration of a surface would be termed “a recovery” rather than “a repair”.

Repairing a defect may include repairing a defect that is a source of a leak. The leak may be an active leak from which material is escaping during the repair process, meaning that the method of the present invention may be employed to repair a defect without having to stop the leak by isolating and/or draining the object to be repaired.

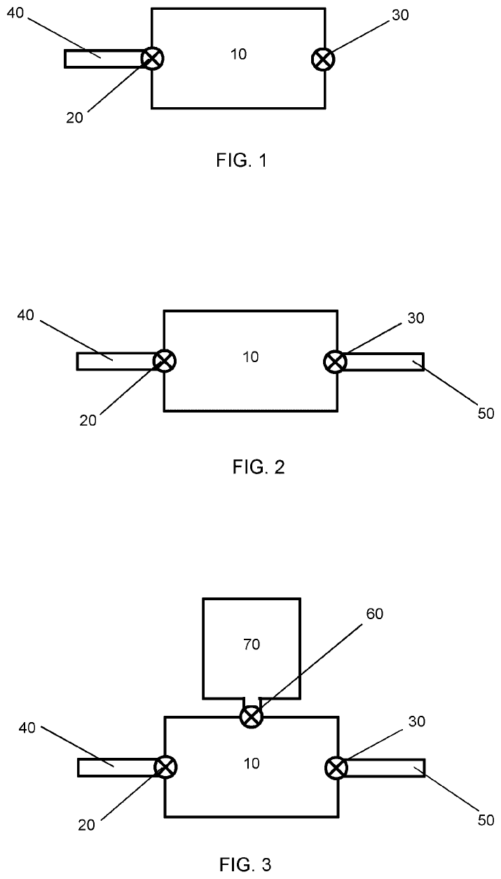

Referring to FIG. 1, the present invention provides an apparatus for repairing a defect in a surface. The apparatus comprises a charge chamber (10), the charge chamber (10) comprising a pressure inlet (20) and an outlet (30), and a pressure line (40) connectable to a pressure source that provides a pressurizing fluid. In operation, a bolus of at least partially liquid alloy is provided in the charge chamber (10), the apparatus is arranged such that the outlet (30) is directed towards the defect, and the bolus is ejected from the charge chamber (10) along a pathway between the outlet (30) and the defect. The bolus impacts the defect, deforming to match its contours while it is in the at least partially liquid state. While in contact with the defect, the bolus cools and solidifies, replacing any missing material and restoring functionality to the object comprising the surface in which the defect was located.

In this embodiment, the charge chamber (10) includes a heater that is configured to heat the alloy to at least its melting point. The pressure inlet (20) and the outlet (30) each comprise a valve that is operable to be rapidly switched between an open and a closed position (e.g. each may be a ball, butterfly, needle, or solenoid valve). In embodiments, the outlet (30) may additionally comprise a nozzle to ensure that the bolus travels along the intended pathway.

Ejection of the bolus from the charge chamber (10) is effected by exposing it to the pressurized fluid from the pressurized fluid source while the outlet (30) is open. The entire quantity of at least partially liquid alloy held in the charge chamber (10) is ejected as a single, contiguous mass: the bolus. This is in contrast to the formation of a spray, where discontinuous parts of the at least partially liquid alloy are broken off and accelerated as individual droplets (e.g. by simultaneously introducing pressurized fluid and at least partially liquid alloy to the charge chamber (10) when the outlet (30) is open).

Due to its deformable nature, gradual exposure of the bolus to pressure may cause it to break-up, forming a spray. If the pressure is introduced gradually while the bolus is able to move, the risk of ‘breakthrough’ (where the pressurized fluid forms a channel through the bolus, reducing the rate of acceleration and increases the likelihood of the bolus breaking up to form a spray) is increased. Ejection of the bolus therefore requires acceleration through rapid exposure to the pressurized fluid. This may be achieved in one of the following ways:

In a first mode, the outlet (30) and pressure inlet (20) are opened simultaneously. This mode traps the bolus in the charge chamber (10) until acceleration occurs, ensuring that it cannot begin to flow prematurely (e.g. under gravity). However, it requires a high degree of coordination between the outlet (30) and the pressure inlet (20).

In a second mode, the outlet (30) is opened before the pressure inlet (20) is opened. This risks the bolus beginning to flow from the outlet (30) prematurely, but means that only the pressure inlet (20) is required to open rapidly.

In a third mode, the pressure inlet (20) is opened before the outlet (30). This risks the bolus beginning to flow from the pressure inlet (20), along the pressure line (40), but means that only the outlet (30) is required to open rapidly.

In each case, the pressure differential between the pressurized fluid in the pressure line (40) and atmospheric pressure beyond the outlet (30) causes the bolus to be accelerated in the direction of the outlet (30) and, if positioned appropriately, towards the defect.

In embodiments, the apparatus further includes one or more sensors. For example, the apparatus may include a pressure sensor in the pressure line (40), to ensure that the pressurized fluid has a sufficient pressure to accelerate the bolus, and/or a temperature sensor in the charge chamber (10) to ensure that the at alloy is at least partially liquid. Information gathered by these sensors may be communicated to the operator (e.g. to inform them that the apparatus is ‘ready’ or ‘not ready’) and/or to a control system.

The embodiment of FIG. 2 corresponds to the embodiment of FIG. 1, with the addition of a delivery line (50) in fluid connection with the outlet (30). If a nozzle is used, the delivery line (50) is located between the outlet (30) and the nozzle. In use, the delivery line (50) defines the pathway between the outlet (30) and the defect, ensuring that the bolus is delivered accurately even at greater distances. As the bolus is at least partially liquid, it can be considered to flow down the delivery line (50) as a stream, following any curves in the pathway that the delivery line (50) defines.

In this embodiment, the delivery line (50) is flexible, allowing the pathway to be non-linear. This makes positioning of the apparatus relative to the defect simple, as only the terminal end of the delivery line (50) will require exact positioning. Furthermore, it permits the repair of defects in otherwise inaccessible locations (e.g. in tightly confined spaces).

In other embodiments, the flexible delivery line (50) may further comprise a robotic positioning system (e.g. a snake arm robot) able to autonomously position the delivery line. This allows the apparatus to be used in hazardous environments without risking the safety of the human operator.

The embodiment of FIG. 3 corresponds to the embodiment of FIG. 2, with the addition of an alloy chamber (70) in fluid communication with the charge chamber (10) via an alloy inlet (60). This arrangement allows for easy loading of the alloy into the charge chamber (10), making the apparatus quicker to use.

The alloy inlet (60) includes a valve to mediate the movement of alloy between the alloy chamber (70) and the charge chamber (10). It should be noted that this valve should be closed during propulsion of the bolus. The charge chamber (10) may comprise the heating element as described above. Alternatively, or additionally, the alloy chamber (70) may comprise a heating element configured to heat the alloy to at least its melting point.

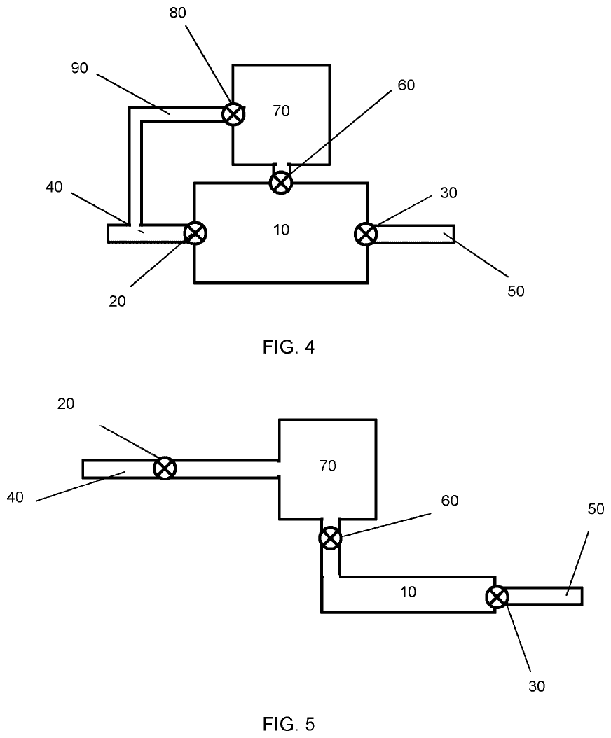

The embodiment of FIG. 4 corresponds to the embodiment of FIG. 3, with the addition of a balance line (90) in fluid connection with the pressure line (40) and the alloy chamber (70), the latter being connected via a balance inlet (80).

The balance line (90) provides the motive force needed to transfer alloy from the alloy chamber (70) to the charge chamber (10). The balance line (90) also permits the apparatus to be operated in a ‘spray mode’ through simultaneous introduction of alloy and pressurized fluid while the outlet (30) is open. The balance line (90) also permits the apparatus to be operated in a ‘jet mode’ through pressurizing the entire contents of the alloy chamber (e.g. by opening the outlet (30) and balance inlet (80) while the pressure inlet (20) is closed). Alternatively, the apparatus may be operated in the ‘jet mode’ through the provision of an excessive quantity of at least partially liquid alloy in the charge chamber, this allows the alloy to be ejected as a continuous flow, rather than as a discrete bolus.

The embodiment of FIG. 5 has the pressurising fluid route via the alloy chamber (70) and charge chamber (10), such that alloy inlet (60) also acts as pressure inlet (10) and alloy chamber (70) acts as a continuation of pressure line (40). In this embodiment, the provision of a motive force to transfer the alloy from the alloy chamber (70) to the charge chamber (10) will also provide the motive force to fire the bolus from the charge chamber when the pressure outlet (30) is opened.

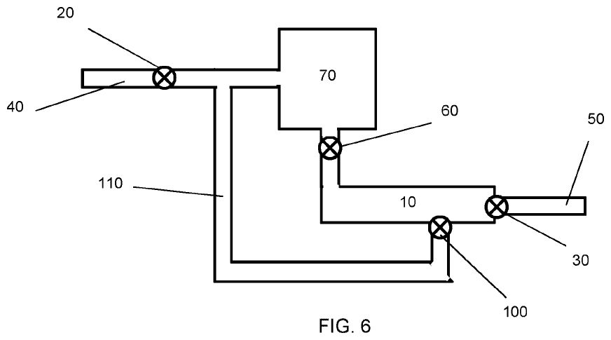

The embodiment of FIG. 6 corresponds to the embodiment of FIG. 5 with the addition of a purge line (110) and purge valve (100) for operational benefits of being able to purge the line of any debris, without disturbing the alloy in the alloy chamber (70). When operating in bolus mode to eject alloy from the system, the purge valve (100) remains closed throughout the operation.

The purge line (110) also permits the apparatus to be operated in a ‘spray mode’ through simultaneous introduction of alloy and pressurized fluid into the charge chamber (10) while the outlet (30) is open. The purge line (110) also permits the apparatus to be operated in a ‘jet mode’ through pressurizing the entire contents of the alloy chamber.

It will be understood that a purge line (110) and purge valve (100) may be incorporated into any embodiment mentioned herein to provide the function of purging the line of debris. In embodiments, the purge valve (100) and outlet (30) are combined, for example, in the form of a three-way valve to pass pressurized fluid, at least partially liquid metal, or a combination thereof through the delivery line as required.

When operated in any of the foregoing modes, it may be advantageous to fit the site of the defect with a collar or mould to ensure that the alloy (whether in the form of a bolus, spray, or jet) is directed to the site of the defect accurately. In a particular embodiment, a collar is used to define a volume around the defect into which the alloy is injected. Advantageously, the collar or mould defines a volume that encircles the object in which the defect is located, such that removal of the solidified alloy requires not just moving, but also breaking, of the solidified alloy.

### EXAMPLES

The invention will now be described by reference to the following non-limiting examples.

### Example 1

An apparatus as described in FIG. 4 was used to repair active leaks in steel pipe with a 1″ (2.54 cm) outer diameter and having a 1 mm diameter hole formed therein. Water was exiting each leak at the indicated velocity. In each example, the following process steps were followed:
1. The heaters were turned on and the required alloy chamber and delivery line temperatures were set;
2. The pressurized fluid (in this instance Nitrogen) in the pressure line was brought to the required pressure;
3. Alloy (in this instance Field's metal (32.5 wt % Bi, 51 wt % In, 16.5 wt % Sn), with a melting point of 62° C.) was added to the heated alloy chamber and allowed to melt;
4. The valves comprising the balance inlet and alloy inlet were opened, transferring the molten alloy to the charge chamber;
5. The valves comprising the balance inlet and the alloy inlet were closed;
6. The delivery line was positioned so that the nozzle at its terminus was directed toward the active leak;
7. The valves comprising the pressure inlet and outlet were opened simultaneously to eject the molten alloy in a single ‘charge’; and
8. The molten alloy was allowed to cool while in contact with the defect.

As a test of the effectiveness of each repair, the water within the pipe was then pressurized until failure of the repair.

| Test | Parameter | Value | |
|---|---|---|---|
| 1 | Leak Rate | 1.5 | ml/s |
| | Alloy Chamber Temperature | 130° | C. |
| | Delivery Line Temperature | 88° | C. |
| | Fluid (N₂) pressure | 12 | Barg |
| | Repressurisation achieved before | 5 | Barg |
| | leak | | |
| 2 | Leak Rate | 4 | ml/s |
| | Alloy Chamber Temperature | 92° | C. |
| | Delivery Line Temperature | 133° | C. |
| | Fluid (N₂) pressure | 10 | Barg |

| | |
|---|---|
| Repressurisation achieved before | Wept at 1 Barg |
| leak | |

### Example 2

An apparatus as described in FIG. 5 was used to repair defects in stainless steel. Water was not flowing at time of repair but a leak rate was taken prior to sealing. For each example the following steps were followed:
1. The heaters were turned on and the required alloy chamber, charge chamber and delivery line temperatures were set;
2. Alloy (in this instance Field's metal (32.5 wt % Bi, 51 wt % In, 16.5 wt % Sn), with a melting point of 62° C.) was added to the heated alloy chamber in solid form and allowed to melt;
3. The pressurized fluid (in this instance Nitrogen) in the pressure line was brought to the required pressure;
4. The delivery line was positioned manually but held by a stand at a known distance and angle incident to the defect
5. The valve comprising the pressure inlet was opened
6. The valve comprising the alloy inlet was opened, transferring the molten alloy to the charge chamber;
7. The valve comprising the pressure outlet was opened to eject the molten alloy in a single ‘charge’; and
8. The molten alloy was allowed to cool while in contact with the defect.

As a test of the effectiveness of each repair, the water within the pipe was then pressurized to a maximum of 15 barg and the leak rate determined.

| Test | Parameter | Value | |
|---|---|---|---|
| 3 | Defect size | 2.9 mm × 0.1 mm | |
| | Pre Leak Rate at 15 barg | 29.8 | ml/s |
| | Alloy Chamber Temperature | 90° | C. |
| | Charge Chamber Temperature | 90° | C. |
| | Delivery Line Temperature | 90° | C. |
| | Fluid (N₂) pressure | 4 | barg |
| | Alloy mass | 34 | g |
| | Distance between nozzle and defect | 4 | cm |
| | Post Leak Rate at 15 barg | 0 | ml/s |
| 4 | Defect size | 6.4 mm × 0.5 mm | |
| | Pre Leak Rate at 15 barg | 51.42 | ml/s |
| | Alloy Chamber Temperature | 90° | C. |
| | Charge Chamber Temperature | 90° | C. |
| | Delivery Line Temperature | 90° | C. |
| | Fluid (N₂) pressure | 6 | barg |
| | Alloy mass | 40 | g |
| | Distance between nozzle and defect | 6 | cm |
| | Post Leak Rate at 15 barg | 1.13 | ml/s |

### Example 3

An apparatus as described in FIG. 2 was used to repair defects in a straight union stainless steel connection joining 2 1″ copper pipes. A 4.5 barg flowing nitrogen gas leak was flowing at time of sealing. A mould was used around the repair site. The following process steps were followed:
1. The heaters were turned on and the required alloy chamber, charge chamber and delivery line temperatures were set;
2. Alloy (in this instance Field's metal (32.5 wt % Bi, 51 wt % In, 16.5 wt % Sn), with a melting point of 62° C.) was added to the heated alloy chamber in solid form and allowed to melt;
3. The mould was put in place around the repair site;
4. The delivery line was connected to the mould
5. The pressurized fluid (in this instance Nitrogen) in the pressure line was brought to the required pressure;
6. The valve comprising the pressure inlet was opened
7. The valve comprising the pressure outlet was opened to eject the molten alloy in a single ‘charge’;
8 The molten alloy was allowed to cool while in contact with the defect; and
9. The mould was removed.

| Test | Parameter | Value |
|---|---|---|
| 5 | Defect type | Scratched Ferrule |

| | | |
|---|---|---|
| Pre Leak Rate at 4.5 barg | 80.6 | ml/min |
| Alloy Chamber Temperature | 110° | C. |
| Charge Chamber Temperature | 100° | C. |
| Delivery Line Temperature | 100° | C. |
| Fluid (N₂) pressure | 9 | barg |
| Alloy mass | 600 | g |
| Mould temperature | 20° | C. |
| Post Leak Rate at 4.5 barg | 1.2 | ml/min |

### Example 4

An apparatus as described in FIG. 2 was used to repair defects in a 2″ elbow connection between stainless steel pipework. A leak of 0.2 barg dripping mineral oil leak was flowing at time of sealing. A mould was used around the repair site. The following process steps were followed:
1. The heaters were turned on and the required alloy chamber, charge chamber and delivery line temperatures were set;
2. Alloy (in this instance a bismuth alloy (57 wt % Bi, 26 wt % In, 17 wt % Sn), with a melting point of 78° C.) was added to the heated alloy chamber in solid form and allowed to melt;
3. The mould was put in place around the repair site;
4. The delivery line was connected to the mould
5. The pressurized fluid (in this instance Nitrogen) in the pressure line was brought to the required pressure;
6. The valve comprising the pressure inlet was opened
7. The valve comprising the pressure outlet was opened to eject the molten alloy in a single ‘charge’;
8 The molten alloy was allowed to cool while in contact with the defect; and
9. The mould was removed.

| Test | Parameter | Value |
|---|---|---|
| 6 | Defect type | Scratched threads |

| | | |
|---|---|---|
| Pre Leak Rate | 0.42 | g/min |
| Alloy Chamber Temperature | 130° | C. |
| Charge Chamber Temperature | 130° | C. |
| Delivery Line Temperature | 100° | C. |
| Fluid (N₂) pressure | 4 | barg |
| Alloy mass | 500 | g |
| Mould temperature | 24° | C. |
| Post Leak Rate | 0.01 | g/min |

These examples show that the method and apparatus of the present invention may be used to effect the repair of surface defects, specifically that they can be used to repair defects from which material is escaping. The examples further show that repairs effected by the method and apparatus of the present invention are robust, able to withstand significant pressure differentials across the repaired surface.

1. A method of repairing a defect in a surface comprising:
a) providing a bolus of an at least partially liquid alloy in a charge chamber, the charge chamber having a closable outlet and a closable pressure inlet;
b) introducing a pressurized fluid to the charge chamber via the pressure inlet and accelerating the bolus such that the bolus is ejected from the charge chamber via the outlet;
c) directing the bolus along a pathway between the charge chamber and the defect such that the bolus contacts the defect; and
d) solidifying the at least partially liquid alloy while it is contact with the defect.

2. The method of claim 1, wherein the directing the bolus to the defect comprises providing a delivery line that defines at least a portion of the pathway.

3. The method of claim 2, wherein the delivery line is positioned by a robot.

4. The method of claim 2, wherein the delivery line is operable to at least one of limit heat loss from the bolus and provide heat to the bolus.

5. The method of claim 1, wherein the providing the bolus to the charge chamber comprises one of:
i) at least partially melting a solid alloy and introducing the resulting at least partially liquid alloy into the charge chamber; and
ii) introducing the solid alloy to the charge chamber and at least partially melting in situ.

6. The method of claim, wherein the pressurized fluid is at least one of:
i) heated;
ii) a compressed gas;
iii) steam; and
iv) has a pressure up to about 30 bar.

7. The method of claim 1, wherein the alloy is selected from the group consisting of bismuth alloys, indium alloys, antimony alloys, tin alloys, lead alloys and gallium alloys.

8. The method of claim 1, wherein in the introducing of a pressurized fluid to the charge chamber via the inlet and accelerating the bolus such that the bolus is ejected from the charge chamber via the outlet, one of:
i) the outlet and pressure inlet are opened simultaneously so that the bolus is ejected as the pressurized fluid is introduced;
ii) the outlet is opened first and the pressure inlet is opened second so that the bolus is ejected as the pressurised fluid is introduced; and
iii) the pressure inlet is opened first and the pressurized fluid is introduced to the charge chamber, and the outlet is opened second so that the bolus is ejected from the charge chamber as the outlet is opened.

9. The method of claim 1, wherein the defect is an active leak.

10. The method of claim 1, further comprising a cleaning step wherein a cleaning fluid is delivered to the defect.

11. The method of claim 1, wherein the bolus penetrates the defect.

12. The method of claim 1, further comprising the step of placing a mould around the defect prior to the step of directing the bolus along a pathway between the charge chamber and the defect such that the bolus contacts the defect, the mould operable to hold the alloy in contact with the defect.

13. An apparatus for repairing defects, the apparatus comprising:
a charge chamber for holding at least partially liquid alloy, the charge chamber comprising a pressure inlet and an outlet; and
a pressure line in fluid connection with the pressure inlet and connectable to a pressurized fluid source.

14. The apparatus of claim 13, further comprising a delivery line in fluid connection with the outlet.

15. The apparatus of claim 14, wherein the delivery line comprises at least one of:
i) a flexible line;
ii) a handle proximate to the outlet;
iii) a robot operable to position the delivery line;
iv) insulation and/or heating apparatus;
v) a nozzle at its terminus; and
vi) a handle proximate the outlet, the handle comprising means for releasing the at least partially liquid alloy.

16. The apparatus of claim 13, wherein the charge chamber further comprises an alloy inlet.

17. The apparatus of claim 16, wherein the apparatus further comprises an alloy chamber in fluid connection with the alloy inlet.

18. The apparatus of claim 17, wherein the alloy chamber further comprises a balance inlet and the apparatus further comprises a balance line in fluid connection with the balance inlet.

19. The apparatus of claim 13, wherein the charge chamber comprises at least one of insulation and a heater.

20. The apparatus of claim 13, wherein the apparatus further comprises at least one of (a) one or more sensors and (b) a control system.

21. The apparatus of claim 13, wherein the apparatus further comprises a deflection line.

22. The apparatus of claim 13, wherein the apparatus further comprises a purge line.

23. The apparatus of claim 13, further comprising a housing containing one or more of the charge chamber, at least a portion of the pressure line, at least a portion of a delivery line, a alloy chamber if present, at least a portion of a balance line, and the purge line.

24. Use of the apparatus as defined in of claim 13 to apply a bolus of at least partially liquid alloy to a defect in a surface.

25. Use of the apparatus as defined in of claim 13 to apply a spray of at least partially liquid alloy to a defect in a surface.

26. Use of the apparatus as defined in of claim 13 to apply a jet of at least partially liquid alloy to a defect in a surface.
